(19) United States
(12) Patent Application Publication
(10) Pub. No.: US 2026/0225440 A1
(43) Pub. Date: Aug. 6, 2026

(54) SYSTEMS FOR INSTALLING A COMPRESSED GAS FUEL SYSTEM IN A VEHICLE AND METHODS OF USING THE SAME

(71) Applicant: NATURAL GAS FUEL SYSTEMS, LLC, Roanoke, TX (US)

(72) Inventors: Michael ZIMMERMAN, Trophy Club, TX (US); Herbert Clayton NOELKE, V, Roanoke, TX (US); Kurt ALLDREDGE, Grapevine, TX (US); Devraj PATKAR, Colleyville, TX (US)

(73) Assignee: NATURAL GAS FUEL SYSTEMS, LLC, Roanoke, TX (US)

(21) Appl. No.: 19/531,153

(22) Filed: Feb. 5, 2026

Related U.S. Application Data
(60) Provisional application No. 63/754,549, filed on Feb. 5, 2025.

(51) Int. Cl. B60K 15/07; B60K 15/03; B60K 15/073

(52) U.S. Cl. CPC B60K 15/07; B60K 15/03006; B60K 15/073; B60K 2015/03118

(57) ABSTRACT

This disclosure includes a system for installing compressed gas fuel tanks in a vehicle and related methods. Some systems have an installation frame including first and second frame members, and, for each of the first and second frame members, fuel tank mounts configured to be coupled to and along the frame member, each of the fuel tank mounts configured to be simultaneously coupled to the frame member, a compressed gas fuel tank, and a vehicle independently of the frame member such that the fuel tank mount remains coupled to the vehicle when the frame member is decoupled from the fuel tank mount.

### CROSS-REFERENCE TO RELATED APPLICATION

The present application claims priority to U.S. Provisional Application No. 63/754,549 filed Feb. 5, 2025 and entitled “SYSTEMS FOR INSTALLING A COMPRESSED GAS FUEL SYSTEM IN A VEHICLE AND METHODS OF USING THE SAME”, the entire contents of which are incorporated herein by reference.

### BACKGROUND

### A. Field of the Invention

The present invention relates generally to compressed gas fuel systems, and more specifically, to installation frames for installing compressed gas fuel systems on or within a vehicle.

### B. Description of Related Art

Installing a compressed gas fuel system in a vehicle can prove to be a complicated and tedious procedure. For instance, such a compressed gas fuel system can include multiple tanks, fuel conduits connecting the tanks to one another, and/or the like, which often are installed in the vehicle on a component-by-component basis. This procedure can prove costly, time-inefficient, and require specialized labor to accomplish.

### SUMMARY OF THE INVENTION

Some embodiments of the present systems include an installation frame that maintains fuel tanks, and in some instances, fuel conduits connecting those tanks and/or other fuel system components, relative to one another such that the fuel tanks, fuel conduits, and/or other fuel system components can be placed relative to one another within the installation frame and subsequently installed on or within a vehicle in the same relative placements. In some embodiments, after installation on a vehicle, the installation frame can be removed from the vehicle. In some instances, this method can be facilitated by fuel tank mounts configured to be coupled to the installation frame and to the vehicle independently of the installation frame.

The fuel tanks, fuel conduits, fuel tank mounts, and other fuel system components can comprise a fuel system that remains on the vehicle after installation. All such components (or any combination thereof) can be consolidated into a single, pre-manufactured system, in some instances, readily packaged to facilitate transportation, on an installation frame. The installation frame can include two frame members that are disposed on opposing sides of the fuel system and support components thereof through, for example, the fuel tank mounts. The fuel tank mounts can act as supporting structures for the fuel system in relation to the frame members at least by securing the compressed gas fuel tanks (e.g., by securing the necks located on each side of each fuel tank) relative to the frame members. Each fuel tank mount can be removably coupled to one of the two frame members that extend along each side of the fuel system. The frame members can act as temporary supports until the fuel system is mounted on a vehicle.

The installation frame can additionally include a base, which can provide support for the installation frame and a fuel system when connected thereto. The base can include supports that allow for a second base of a second installation frame to be stacked on top of the first installation frame. In this way, multiple installation frames (and the fuel systems supported thereon) can be stacked upon one another to facilitate efficient transportation and storage. Each base can additionally comprise forklift pockets that can assist with the transportation of the installation frame and the fuel system supported thereon.

Once the installation and fuel system are placed near a vehicle ready for installation, lifting points (e.g., disposed along the frame members) can be used to separate the remainder of the installation frame from its base (if present). These lifting points can additionally be used to place the fuel system as desired on the vehicle for purposes of installation. When placed as desired, fasteners can be installed through the fuel tank mounts and into the vehicle, securing the fuel system to the vehicle. As the fuel tank mounts surround and secure each fuel tank, fasteners installed through the fuel tank mounts can secure each tank and related components (e.g., fuel conduits, brackets, pressure-relief valves, and/or the like) to the vehicle. The installation frame (e.g., the frame members thereof) can be subsequently removed from the fuel tank mounts, leaving the fuel system coupled to the vehicle. This can ease the installation process compared to, for example, assembling the fuel system on the vehicle, and in some instances, can reduce the weight of the installed fuel system. The installation frame can be reused, mitigating cost and waste.

Other components can be included with the fuel system, including a fuel management module, a mount on the installation frame for the module, pressure-relief devices, pressure-relief conduits, vents, shut-off valves, and/or the like. The fuel management module can be installed on the vehicle along with the fuel system and can, for example, allow an operator to fill the fuel system through a variety of ports (e.g., a regular fill port, a heavy-duty fill port, a remote fill port, and/or the like), empty the system to a secondary storage, bleed the system, stop the flow of fuel through the system (e.g., by means of a shut-off valve), and/or the like. Pressure-relief devices, pressure-relief conduits, vents, and/or the like can be installed in the fuel system to reduce the risk of harm to the system, vehicle, personnel, and/or the like caused by elevated temperature within or near the fuel system (e.g., due to a fire) and/or elevated pressure within the fuel system.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. Additionally, “substantially parallel” means within 10 degrees of parallel to, and “substantially perpendicular” means within 10 degrees of perpendicular to. In any disclosed embodiment, the terms “substantially,” “approximately,” and “about” may be substituted with “within [a percentage] of” what is specified, where the percentage is 1, 2, 5, or 10%.

The phrase “and/or” means and or or. To illustrate, A, B, and/or C includes: A alone, B alone, C alone, a combination of A and B, a combination of A and C, a combination of Band C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements but is not limited to possessing only those one or more elements. Likewise, a method that “comprises,” “has,” “includes,” or “contains” one or more steps possesses those one or more steps but is not limited to possessing only those one or more steps.

Any embodiment of any of the apparatuses and methods can consist of or consist essentially of-rather than comprise/have/include/contain-any of the described elements, features, and/or steps. Thus, in any of the claims, the phrase “consisting of” or “consisting essentially of” can be substituted for any of the open-ended linking verbs recited above to change the scope of a given claim from what it would otherwise be using the open-ended linking verb.

Further, an apparatus or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers. Non-schematic figures are drawn to scale, meaning the sizes of the depicted elements in each are accurate relative to each other for at least the embodiment shown.

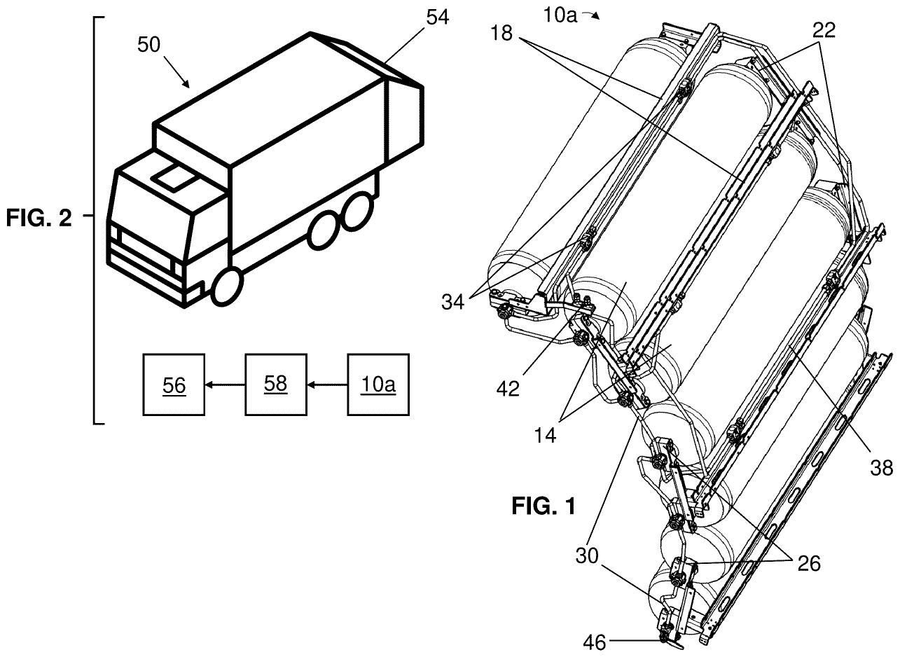

FIG. 1 is a perspective view of a first embodiment of the present fuel systems.

FIG. 2 is a schematic view of a vehicle that can use the fuel system of FIG. 1.

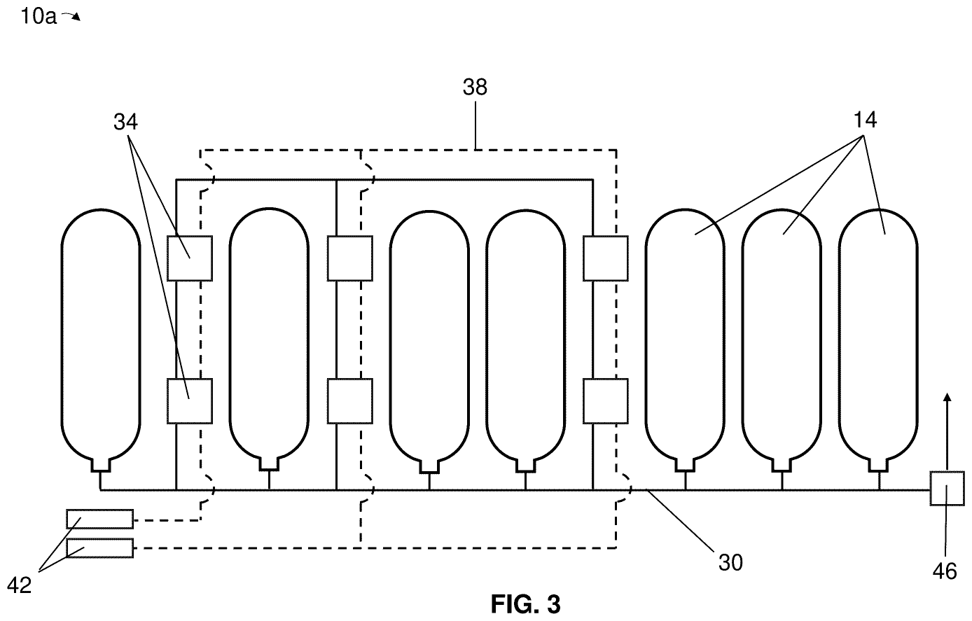

FIG. 3 is a schematic of the fuel system of FIG. 1.

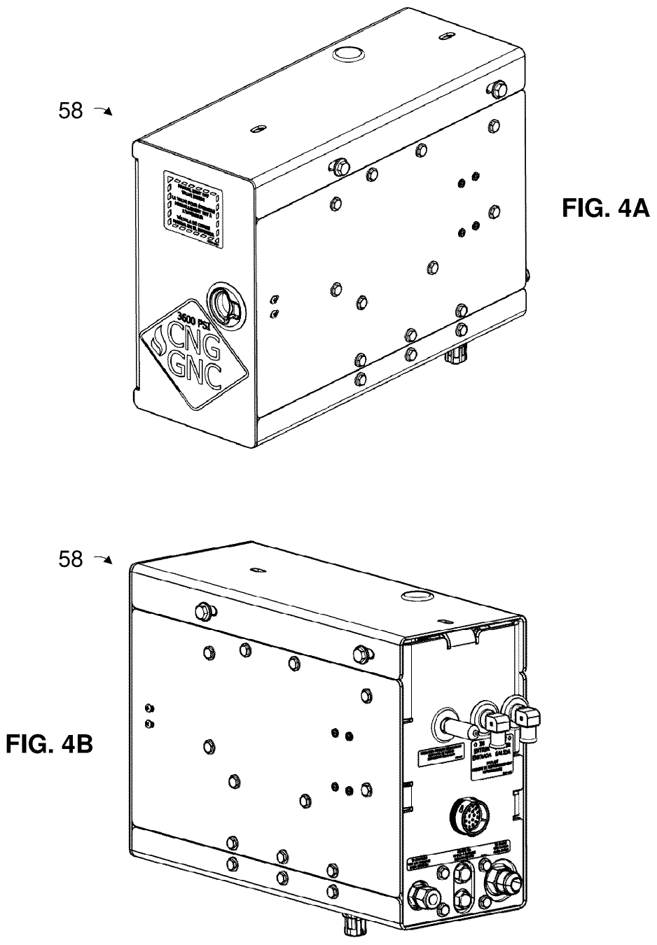

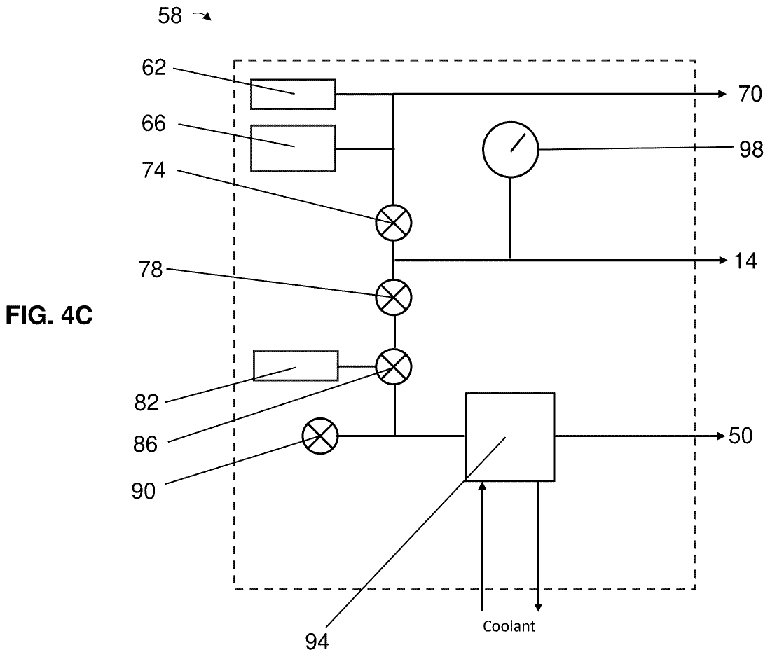

FIGS. 4A and 4B are front perspective and rear perspective views, respectively, of a fuel management module, which can be used in conjunction with the fuel system of FIG. 1.

FIG. 4C is a schematic of the fuel management module of FIGS. 4A and 4B.

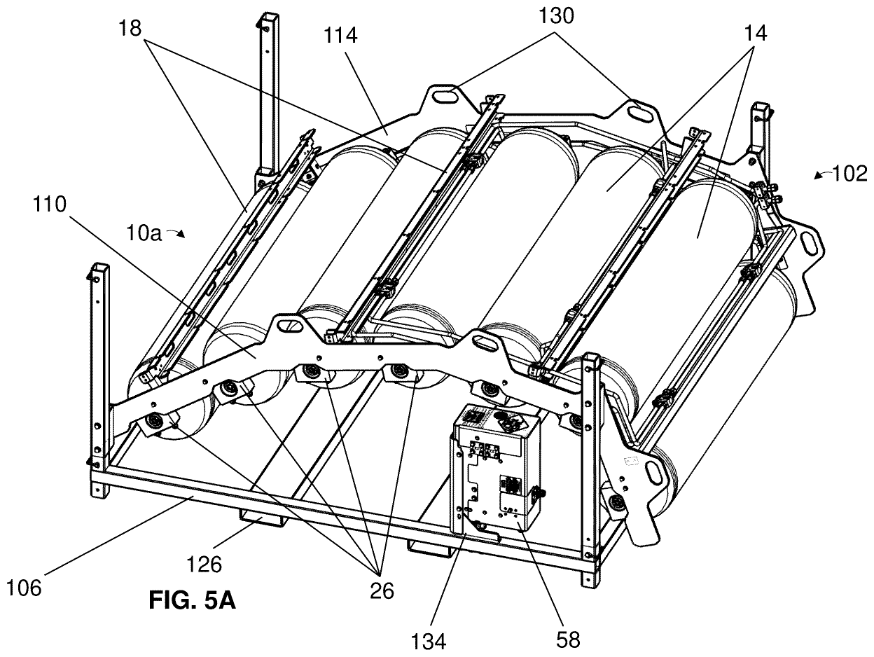

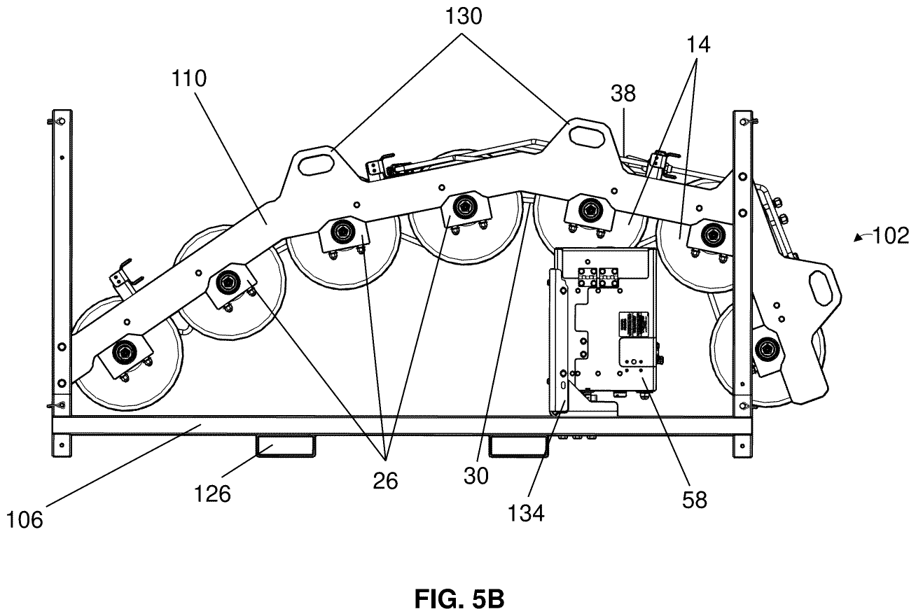

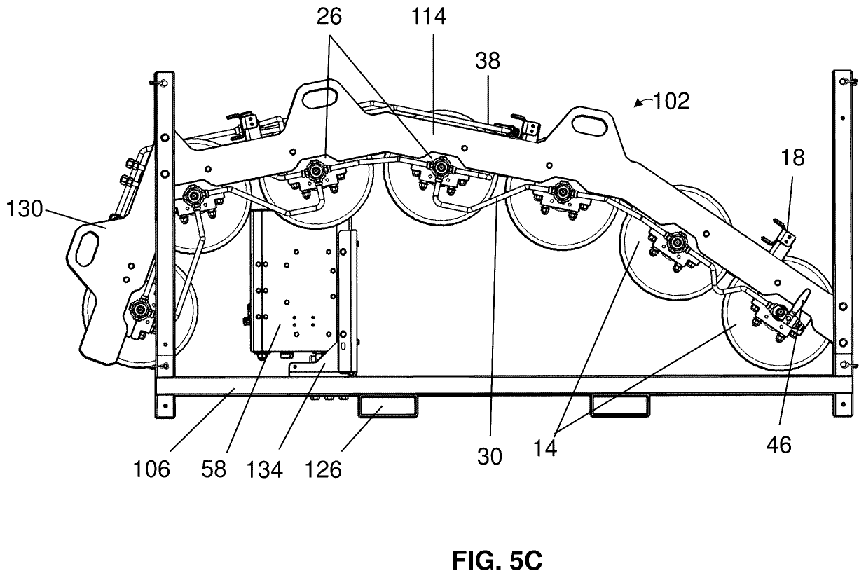

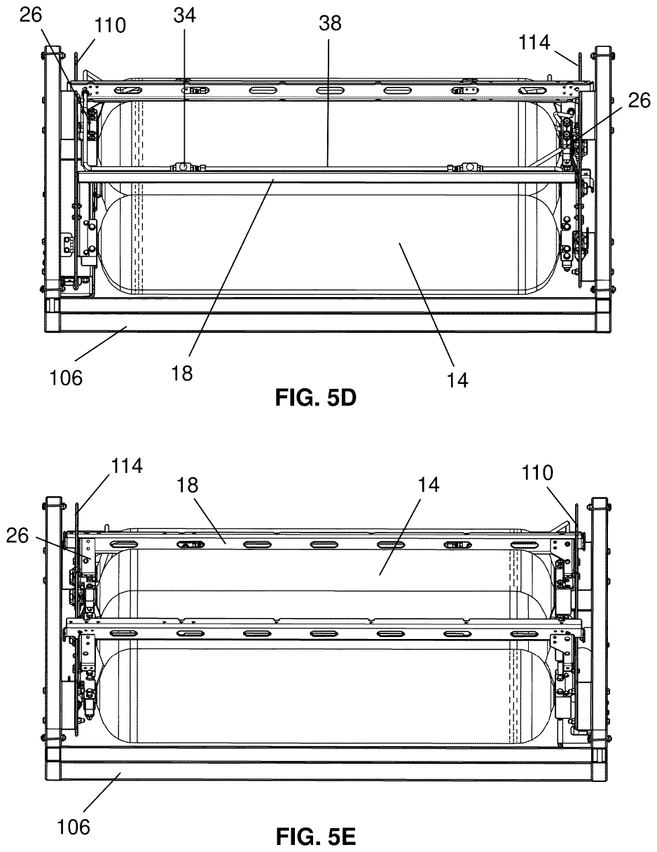

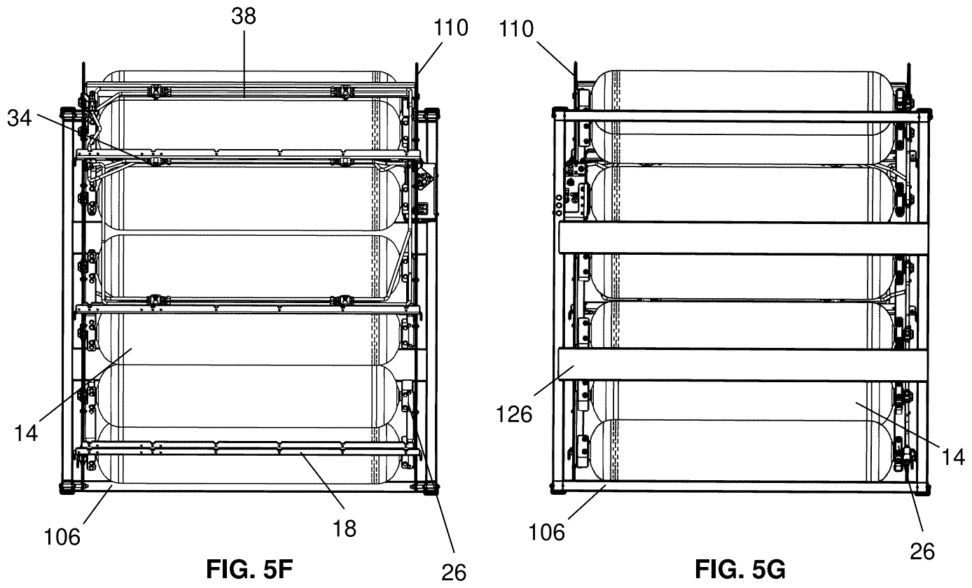

FIGS. 5A-5G are perspective, left, right, front, rear, top, and bottom views, respectively, of a first embodiment of an installation jig supporting the fuel system of FIG. 1.

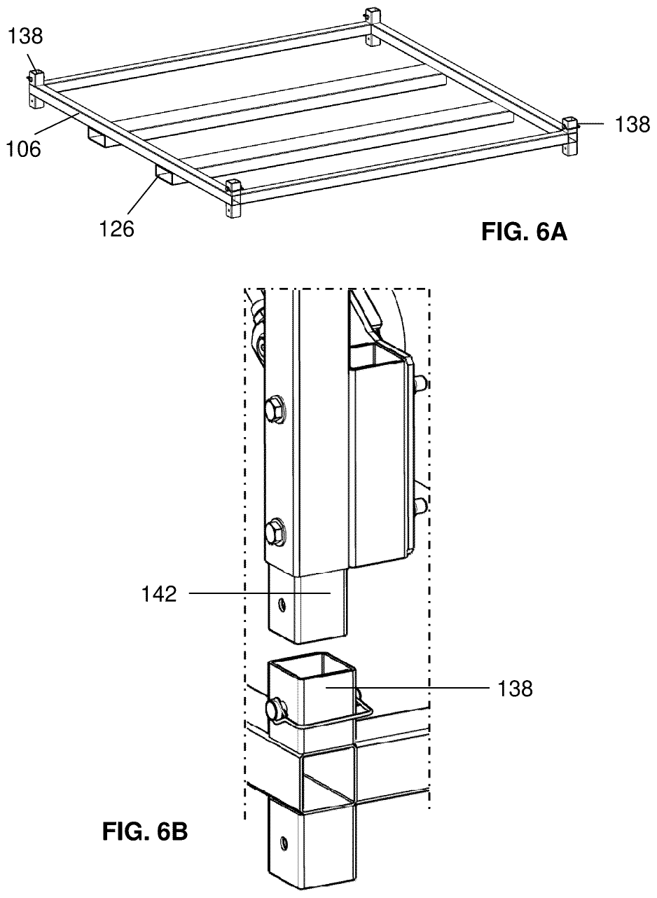

FIG. 6A is a perspective view of a base of the installation jig of FIGS. 5A-5G.

FIG. 6B is an enlarged perspective view of the base of FIGS. 5A-5G, showing an exemplary structure for coupling and decoupling the base from the remainder of the installation jig.

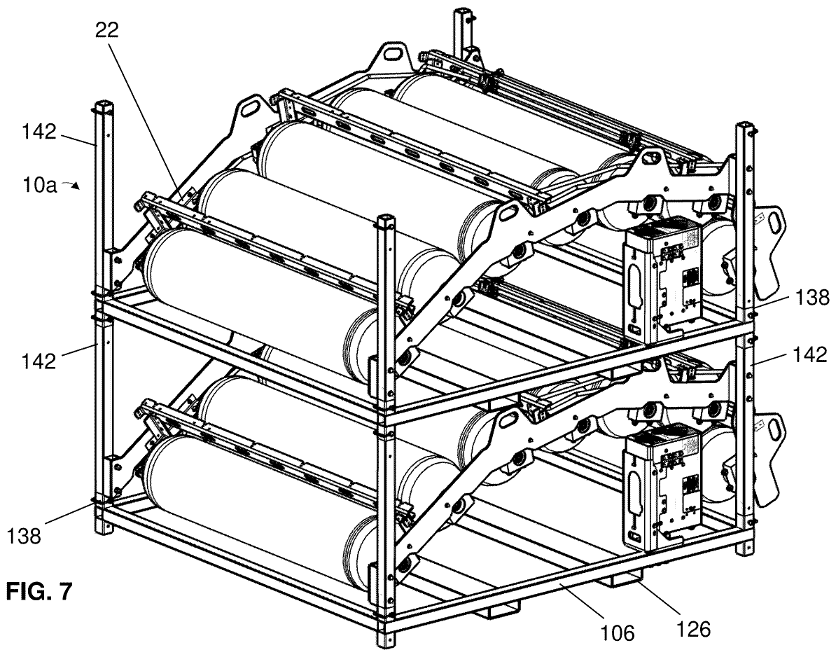

FIG. 7 is a perspective view of a stacked set of the fuel systems and installation jigs of FIGS. 5A-6B.

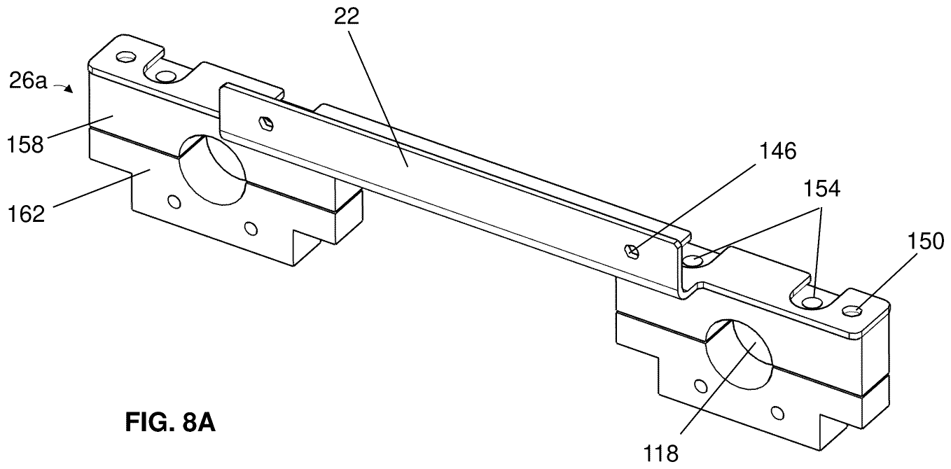

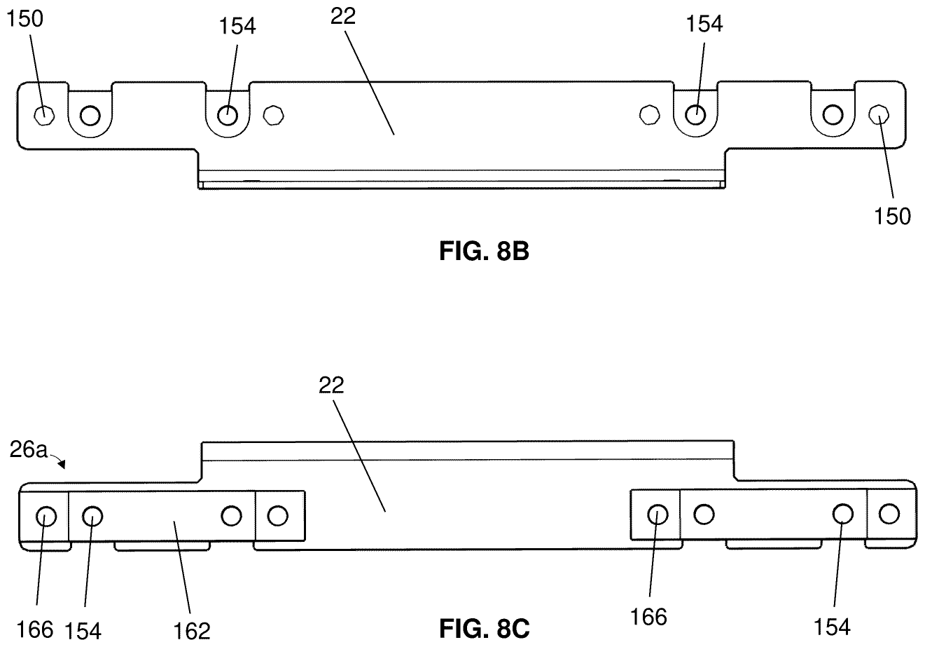

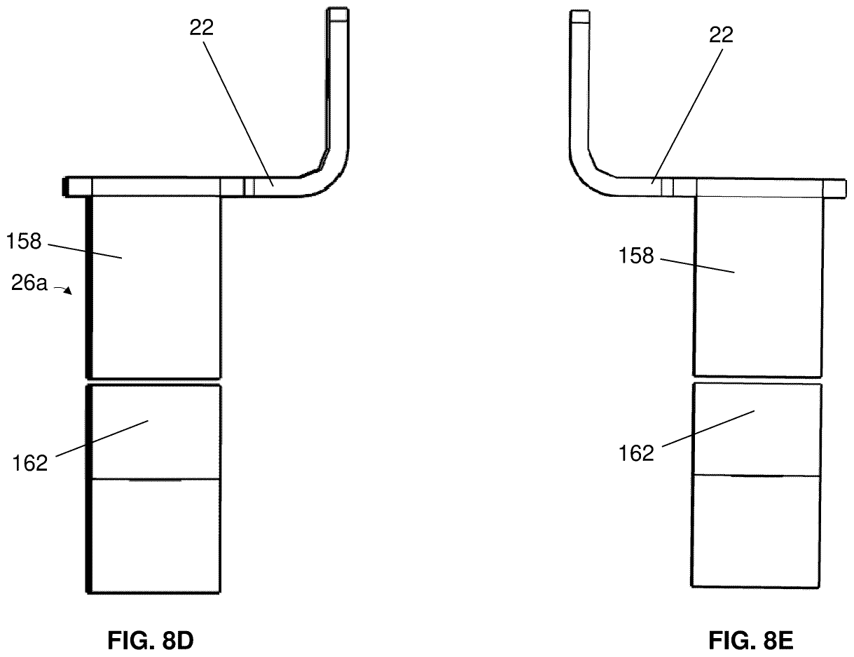

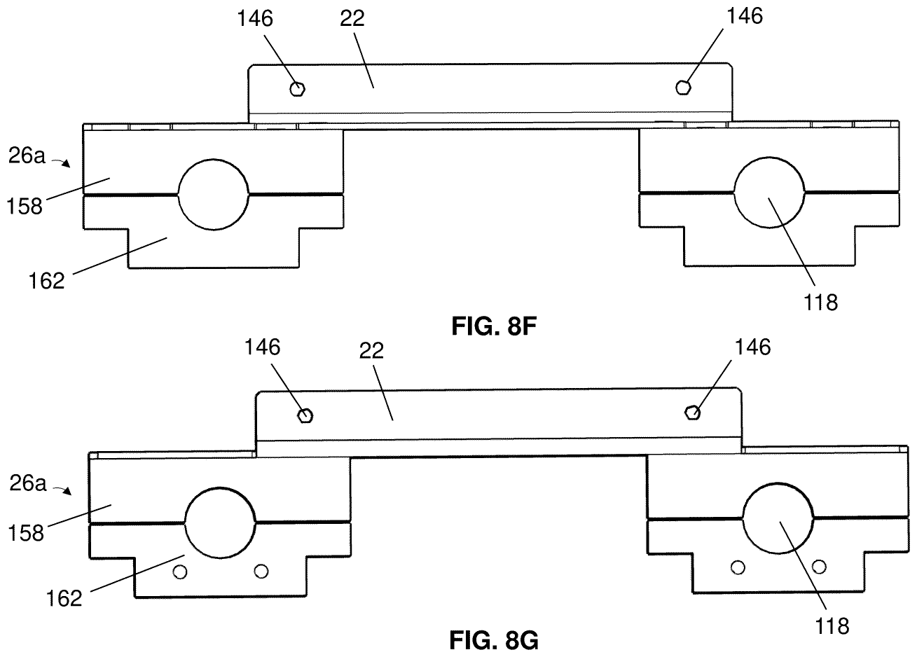

FIGS. 8A-8G are perspective, top, bottom, left, right, rear, and front views, respectively, of a bracket and fuel tank mounts that can be used to facilitate the installation of the fuel system of FIG. 1 in a vehicle using the installation jig of FIGS. 5A-6B.

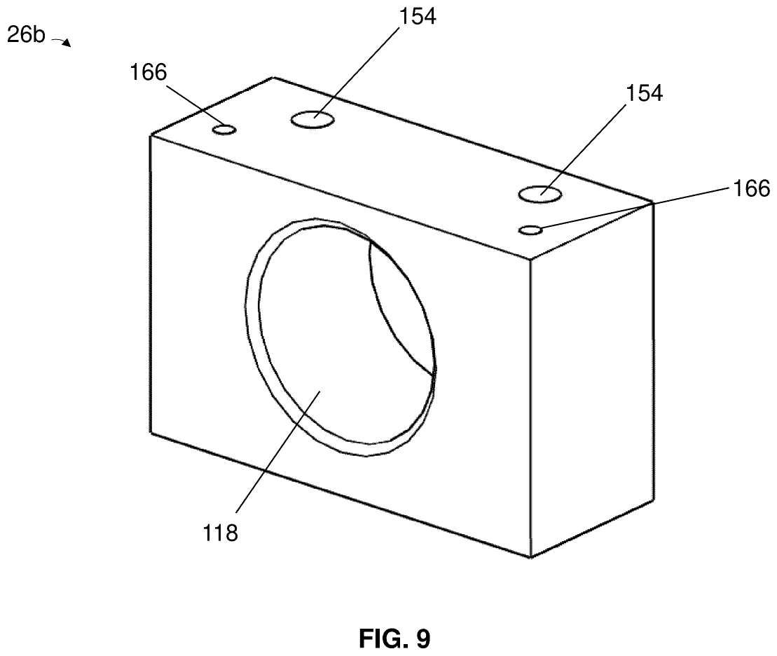

FIG. 9 is a perspective view of a fuel tank mount that can be used to facilitate the installation of the fuel system of FIG. 1 in a vehicle using the installation jig of FIGS. 5A-6B.

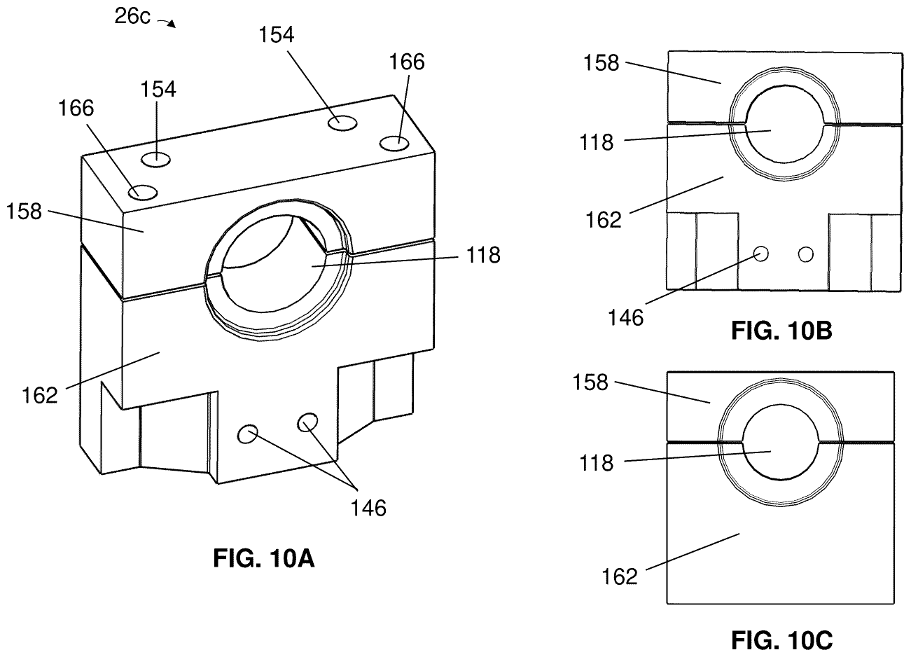

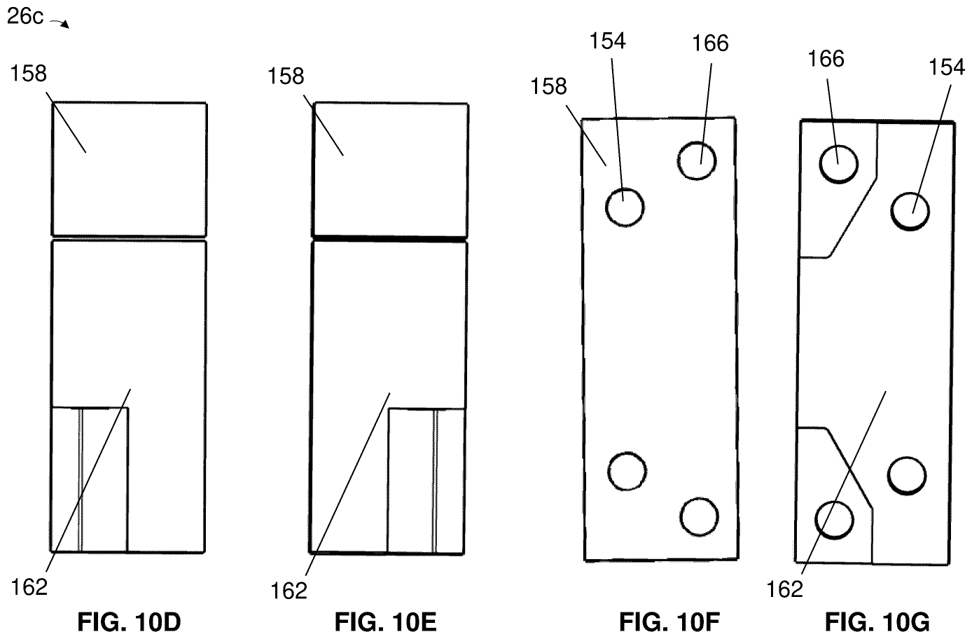

FIGS. 10A-10G are perspective, front, rear, right, left, top, and bottom views, respectively, of a fuel tank mount that can be used to facilitate the installation of a fuel system in a vehicle using an installation jig.

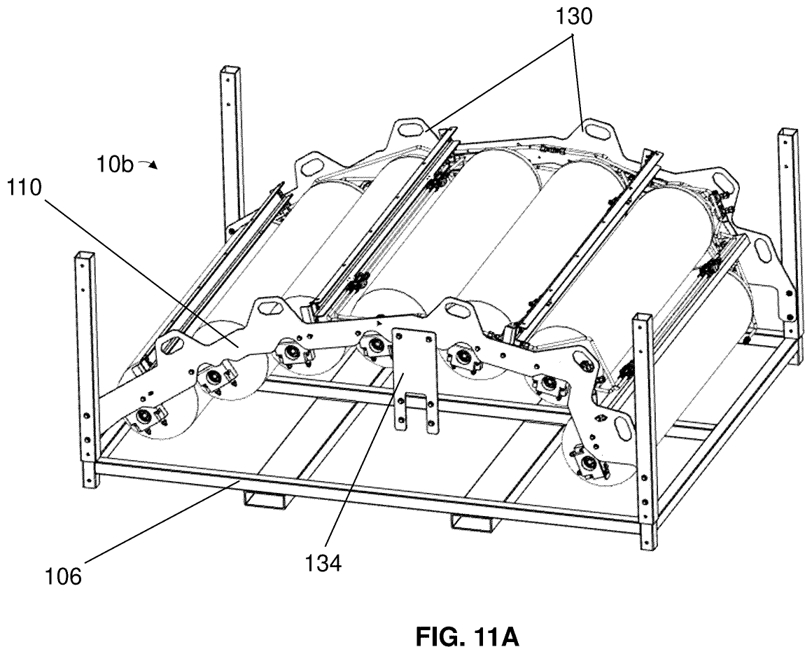

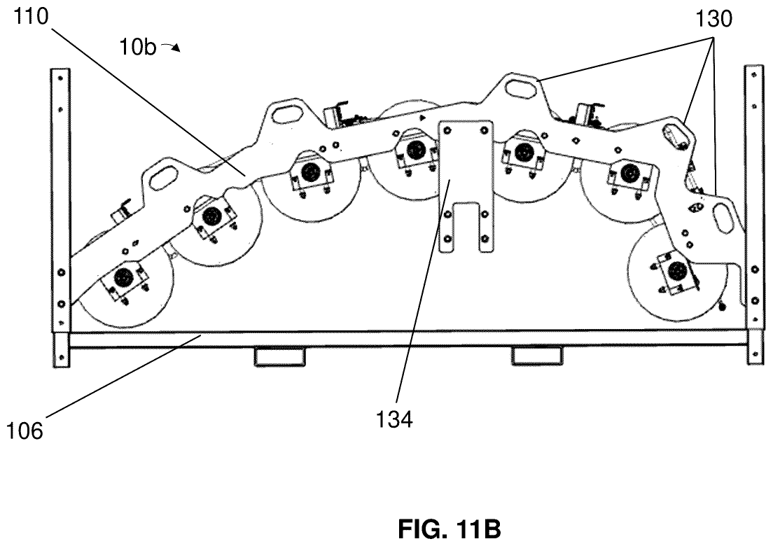

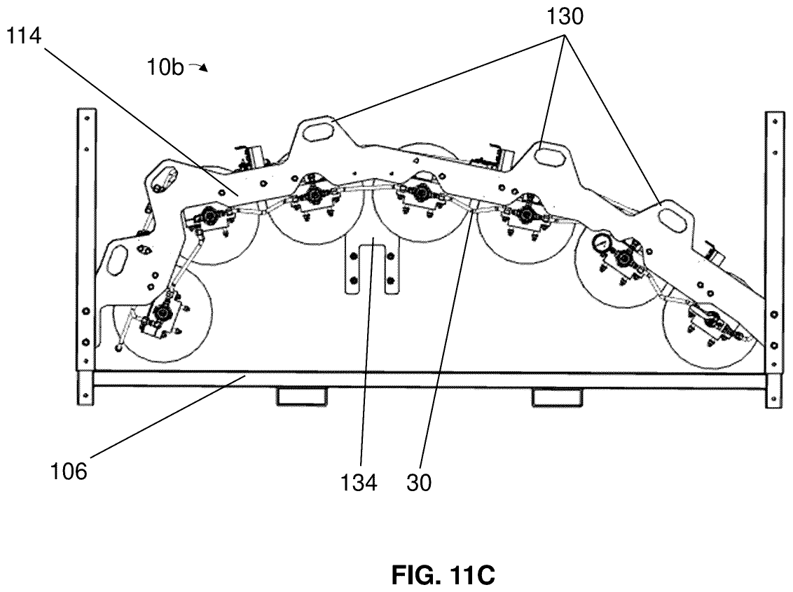

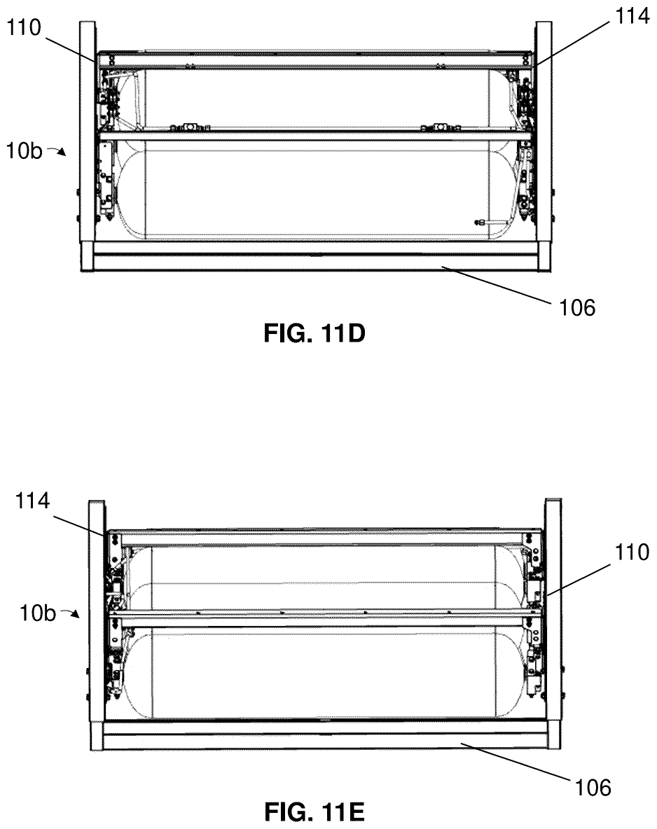

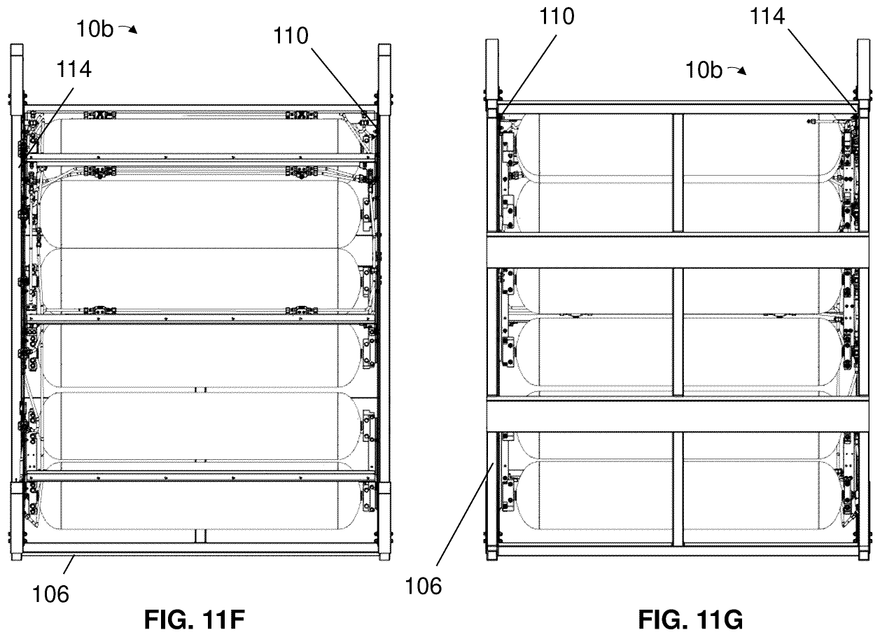

FIGS. 11A-11G are perspective, left, right, front, rear, top, and bottom views, respectively, of a second embodiment of an installation jig supporting a second embodiment of a fuel system.

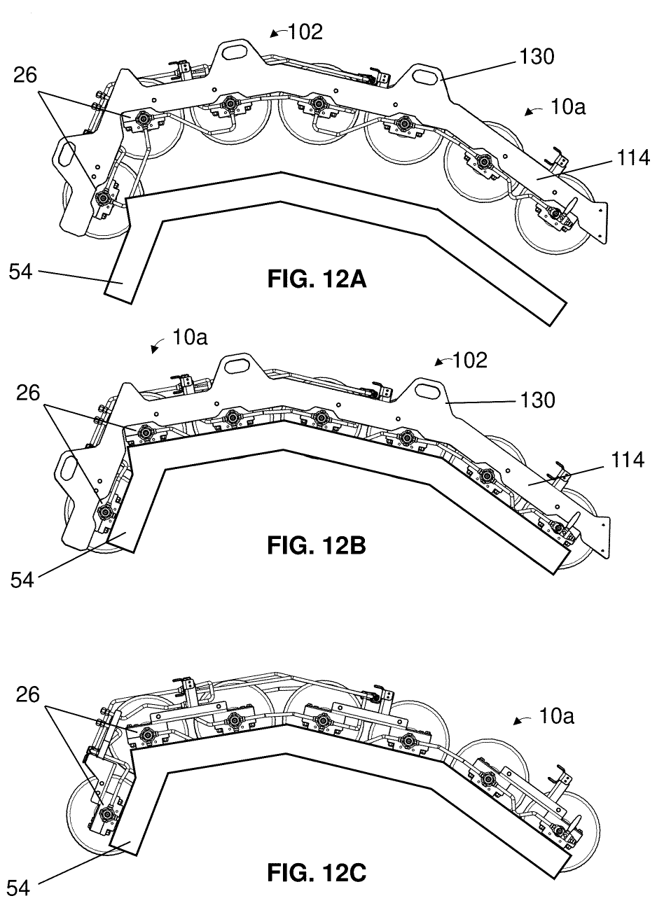

FIGS. 12A-12C depict first, second, and third steps, respectively, of a process for installing the fuel system of FIG. 1 into a vehicle using the installation jig of FIGS. 5A-6B.

### DETAILED DESCRIPTION

Referring now to the drawings, FIG. 1 depicts a first embodiment, hereby referred to as fuel system 10a, of the present fuel systems. Fuel system 10a can comprise a plurality of compressed gas fuel tanks 14, support brackets 18, brackets 22, fuel tank mounts 26, and/or the like, each of which are discussed in more detail below. Provided by way of illustration, fuel system 10a can be a CNG fuel system or a hydrogen fuel system. As later detailed, fuel system 10a can be delivered on an installation frame 102, with fuel conduits 30, and in some instances, other fuel system components, pre-installed, mitigating the need for, e.g., the installation or extensive modification of the conduit system after the fuel system has been mounted on a vehicle. In some configurations, fuel system 10a can additionally comprise pressure-relief devices 34, pressure-relief conduits 38, and vents 42 to mitigate damage to the system and/or vehicle caused by excessive temperature in or around the fuel system or excessive pressure within the fuel system. Fuel system 10a can additionally comprise a shut-off valve 46, which can be used to stop the supply of fuel (e.g., compressed gas) from the fuel system.

FIG. 2 depicts a vehicle 50 including fuel system 10a. As shown, vehicle 10 is a commercial vehicle, such as a box truck, tractor truck, garbage truck, bus, and/or the like. In particular, FIG. 2 shows vehicle 50 as a garbage truck, and fuel system 10a is mounted to a tailgate 54 thereof. In other embodiments, a fuel system-whether or not mounted to a garbage truck-can be mounted behind a cab of a vehicle, underneath the vehicle, on a roof of the vehicle, in a trunk of the vehicle, and/or the like. To be clear, the present fuel systems (e.g., 10a) are usable with other vehicles, including passenger vehicles such as cars and trucks. Fuel system 10a can supply compressed gas to an engine 56 of vehicle 50 (or a fuel cell of the vehicle), in some instances, via a fuel management module 58, described in more detail below.

Referring now to FIG. 3, fuel system 10a is depicted schematically. Compressed gas fuel tanks 14 can be connected to fuel conduits 30 to transfer fuel through fuel system 10a for subsequent delivery to an engine 56 or fuel cell of vehicle 10. Fuel conduits 30 can additionally be connected to pressure-relief devices 34 that can allow fuel to enter pressure-relief conduits 38 should there be, for example, excess pressure in the system, high temperature within and/or proximate to the system, and/or the like. Pressure-relief conduits 38 can be connected to vent(s) 42 to bleed fuel to the atmosphere. Pressure-relief devices 34, pressure-relief conduits 38, and vents 42 can be implemented to improve the safety and integrity of the fuel system. Shut-off valve 46 can be disposed downstream of fuel tanks 14 to either permit or prevent fluid communication between the tanks and the vehicle (e.g., an engine 56 or fuel cell of the vehicle). Disallowing such fluid communication with the vehicle can prove beneficial in the case of an emergency or for maintenance. In some configurations, fuel system 10a can comprise a plurality of compressed gas fuel tanks 14-such as greater than or equal to any one of, or between any two of, four, five, six, seven, or eight compressed gas fuel tanks-wherein the compressed gas fuel tanks can have a collective capacity greater than or equal to any one of, or between any two of, 80, 90, 100, 110, 130, or 150 diesel gallon equivalent (DGE).

Referring now to FIGS. 4A and 4B, fuel management module 58 is depicted. Fuel management module 58 can be installed in vehicle 50 along with fuel system 10a in order to allow for increased functionality and control. For example, fuel management module 58 can allow for the filling, bleeding, de-fueling, and regulating of fuel into, out of, or within fuel system 10a. FIG. 4C depicts fuel management module 58 schematically, wherein the various components that can allow for the aforementioned functionality are shown. Fuel management module 58 can comprise a plurality of fill ports, including (but not limited to) a regular fill port 62, heavy-duty fill port 66, and remote fill port 70. Additionally, fuel management module 58 can comprise a check valve 74 disposed downstream of the fill ports (e.g., 62, 66, and 70) such that the check valve can prevent the flow of fuel back to the fill ports. Fuel management module 58 can additionally comprise a shut-off valve 78, a de-fuel port and de-fuel valve (82 and 86, respectively), and a bleed valve 90. Shut-off valve 78 can be utilized to either permit or prevent fluid communication between fuel management module 58 and the vehicle (e.g., 50). Disallowing fluid communication with the vehicle (e.g., 50) can prove beneficial in the case of an emergency or for maintenance. De-fuel port 82 can be utilized to off-load fuel remaining in the system, for example, in the case of maintenance. By utilizing de-fuel port 82, fuel can be off-loaded to a secondary storage tank. Bleed valve 90 can be utilized as a safety mechanism, or alternatively, as a manual method of emptying remaining fuel. Fuel management module 58 can additionally comprise a fuel regulator 94 that can regulate the flow of fuel to the vehicle. In some embodiments, fuel management module 58 can comprise gauges 98 to provide measurements of the current fuel system status (e.g., pressure, fuel-level, and/or the like). In some configurations, gauges 98 can comprise mechanical gauges. In yet other configurations, gauges 98 can comprise digital gauges.

Referring now to FIGS. 5A-5G, fuel system 10a is shown disposed within installation frame 102. Installation frame 102 can comprise first and second frame members (110 and 114, respectively), and for each of the first and second frame members, fuel tank mounts (e.g., 26a, 26b, or 26c) can be configured to be coupled to and along the frame member. As depicted, a combination of fuel tank mounts 26a and 26b can be utilized for fuel system 10a. To illustrate, fuel tank mounts 26a can be used to connect one end of fuel tanks 14 to first frame member 110, while fuel tank mounts 26b can be used to connect the opposing end of the fuel tanks to second frame member 114. First and second frame members (110 and 114, respectively) can extend substantially parallel to one another and define a space between that can receive compressed gas fuel tanks 14. In some embodiments, each of the frame members (110 and 114, respectively) can comprise a plate. When fuel tank mounts 26a and 26b are coupled to the first and second frame members (110 and 114, respectively), for each set of three consecutive fuel tank mounts along one of the frame members, the longitudinal axis of the neck passageway 118 of the middle fuel tank mount of the set can be disposed outwardly of a plane including the longitudinal axes of the neck passageways of the outer fuel tank mounts of the set. This can, for example, position fuel tanks 14 relative to one another for placement on a tailgate (e.g., 54) of a garbage truck (e.g., 50).

Each of fuel tank mounts 26a, 26b can be configured to be simultaneously coupled to a frame member (110 or 114), a neck 122 (FIG. 3) of a compressed gas fuel tank 14 via a neck passageway 118 of the fuel tank mount, and a vehicle (e.g., 50) independently of the frame member. As such, each fuel tank mount 26a, 26b can remain coupled to the vehicle when a respective frame member (110 or 114) is decoupled from the fuel tank mount. In at least this way, each fuel tank mount 26a, 26b can partially support a compressed gas fuel tank 14 and be coupled to a frame member 110 or 114 for installation, and, in some instances, transportation of fuel system 10a. After fuel system 10a is installed on a vehicle (e.g., 50), first and second frame members (110 and 114, respectively) can then be removed, while fuel tank mounts 26a, 26b and compressed gas fuel tanks 14 remain supported by the vehicle structure. Additionally, support brackets 18 can remain coupled to fuel system 10a after installation on a vehicle, including after frame members 110 and 114 have been removed.

In some configurations, installation frame 102 can include a base 106 configured to be removably coupled to first and second frame members 110 and 114, where the base can be used to facilitate transportation of the installation frame and fuel system 10a supported thereon. To illustrate, base 106 can comprise forklift pockets 126 configured to facilitate the transport of fuel system 10a. Installation frame 102 can additionally comprise lifting points 130 disposed along and coupled to each of the frame members 110 and 114, such that the installation frame can be more readily lifted, manipulated, and placed as needed. For example, a forklift can be utilized to transport fuel system 10a and installation frame 102 (by means of forklift pockets 126 of base 106) close to a vehicle for installation. Then, lifting points 130 can be utilized to separate fuel system 10a and the remainder of installation frame 102 from base 106 and position it appropriately in relation to a vehicle (e.g., 50) for installation. As depicted, base 106 can comprise a module mount 134 configured to removably couple fuel management module 58 to the base. In other configurations, module mount 134 can be disposed on another portion of installation frame 102 (e.g., coupled to one of the first or second frame members 110 or 114). Module mount 134 can ensure that other components required for the operation of fuel system 10a can be included in one package (as shown in FIGS. 5A-5G), facilitating the transportation and ease of installation of the fuel system.

Referring now to FIGS. 6A and 6B, base 106 is depicted. Forklift pockets 126 can be utilized to efficiently move base 106 (and the rest of installation frame 102 and/or fuel system 10a if connected thereto). Connection points 138 can be utilized to stack a second base 106 on top of the first base via the use of supports 142. FIG. 6B shows this interaction, wherein connection point 138 is shown with support 142 being placed such that they can interact as a protrusion-and-recess connection. In other configurations, support 142 and base 106 can be unitary. Referring now to FIG. 7, a stacked set of installation frames 102 and fuel systems 10a are shown to depict the stacking ability of some configurations. As depicted, installation frame 102 supporting second system 10a can be stacked on top of installation frame 102 supporting first system 10a. Such stacking can facilitate the transportation and storage of multiple systems simultaneously.

Referring now to FIGS. 8A-8G, bracket 22 and a first embodiment of a fuel tank mount, hereby referred to as fuel tank mount 26a, are depicted. In some configurations, one or more brackets 22 can each be configured to couple at least one of the fuel tank mounts 26a to at least one of frame members 110 or 114. In particular, brackets 22 can include one or more first openings 146, each extending into the bracket in a first direction and configured to receive a fastener to couple the bracket to one of frame members 110 or 114. Additionally, bracket 22 can include one or more second openings 150, each configured to receive a fastener to couple the bracket to one of the fuel tank mounts. Second openings 150 can each extend into the bracket 22 in a second direction that is substantially perpendicular to the first direction.

Fuel tank mounts 26a can include one or more first passageways 154, each being configured to receive a fastener to couple the fuel tank mount to the vehicle. Additionally, fuel tank mount 26a can comprise first and second fuel tank mount portions (158 and 162, respectively) configured to be coupled together such that the fuel tank mount portions cooperate to define neck passageway 118. Fuel tank mount portions 158 and 162 can additionally define one or more second passageways 166, each configured to receive a fastener to couple the fuel tank mount portions together. In at least this way, the fuel tank mount portions 158 and 162 can be placed around neck 122 of a compressed gas fuel tank 14 such that the neck is disposed within neck passageway 118, and fasteners can be disposed through second passageways 166 to couple the portions together and secure the compressed gas fuel tank. The first and second passageways (154 and 166, respectively) can each extend into fuel tank mount 26a substantially parallel to one another and substantially perpendicular to the first direction. Additionally, first passageways 154 can each have a length that is longer than a length of each of the second passageways 166. The length of first passageways 154 can be longer to allow for coupling to the vehicle while the shorter length of second passageways 166 can allow for securing of compressed gas fuel tanks 14 between fuel tank mount portions 158 and 162 before, during, and after installation of fuel system 10a to the vehicle (e.g., preventing interference between fasteners used to couple fuel tank mount portions 158 and 162 via second passageways 166 and fasteners used to couple fuel tank mount 26a to the vehicle).

Referring now to FIG. 9, a second embodiment of a fuel tank mount, hereby referred to as fuel tank mount 26b, is depicted. Fuel tank mount 26b can include one or more first passageways 154, each configured to receive a fastener to couple the fuel tank mount to the vehicle. Fuel tank mount 26b can comprise a solid piece (rather than two portions). To illustrate, fuel tank mount 26b-whether or not a solid piece-can permit movement of one end of a fuel tank 14 secured thereby, while a fuel tank mount 26a can secure the other end of the fuel tank and prevent movement thereof, thereby securing the fuel tank while allowing for expansion and contraction of the fuel tank. Fuel tank mount 26b can additionally define one or more second passageways 166, each configured to receive a fastener to couple the fuel tank mount to a bracket 22. Similar to fuel tank mount 26a, the first and second passageways (154 and 166, respectively) can each extend into fuel tank mount 26b substantially parallel to one another and substantially perpendicular to the aforementioned first direction. Fuel tank mount 26b can have first passageways 154 bisected by a plane normal to the first direction and parallel to the second direction that is closer to compressed gas fuel tanks 14 than that of the plane that bisects second passageways 166. In at least this way, fasteners can be disposed through second passageways 166 to secure brackets 22 to fuel tank mount 26b while protruding on a plane further outward than that of first passageways 154, thereby allowing for fasteners to be disposed through first passageways and the fuel tank mount to be installed on the vehicle without first removing the securing fasteners from second passageways 166 (and thereby decoupling bracket 22 from the fuel tank mount).

Referring now to FIGS. 10A-10G, a third embodiment of the fuel tank mount, hereby referred to as fuel tank mount 26c, is depicted. Fuel tank mount 26c can be utilized instead of the previously described bracket-and-mount system. Rather than use bracket 22 as a connecting piece to couple frame member 110 or 114 to a fuel tank mount (as is shown in either 26a or 26b), fuel tank mount 26 c can be used to directly connect the frame member to the fuel tank, mitigating the need for a separate bracket. As is depicted in the figures, fuel tank mount 26c can comprise neck passageway 118, first and second passageways (154 and 166, respectively), and additionally, one or more first openings 146 that can each extend into the fuel tank mount in a first direction and can be configured to receive a fastener to couple the fuel tank mount to one of frame members 110 or 114. Fuel tank mount 26c can include one or more first passageways 154, each configured to receive a fastener to couple the fuel tank mount to the vehicle (e.g., 50). Additionally, fuel tank mount 26c can comprise first and second fuel tank mount portions (158 and 162, respectively) configured to be coupled together such that the fuel tank mount portions cooperate to define neck passageway 118. Fuel tank mount portions 158 and 162 can additionally define one or more second passageways 166, each of which can be configurable to receive a fastener to couple the fuel tank mount portions together. Therefore, fuel tank mount portions 158 and 162 can be placed around the neck 122 of a compressed gas fuel tank 14 such that the neck is disposed within neck passageway 118 and fasteners can be disposed through second passageways 166 to couple the portions together and secure the compressed gas fuel tank. First and second passageways (154 and 166, respectively) can each extend into fuel tank mount 26c substantially parallel to one another and substantially perpendicular to the aforementioned first direction. Additionally, first passageways 154 can each have a length that is longer than a length of each of the second passageways 166. The length of first passageways 154 can be longer to allow for coupling to the vehicle while the shorter length of second passageways 166 can allow for securing of the neck 122 of compressed gas fuel tanks 14 between fuel tank mount portions 158 and 162 before, during, and after installation of fuel system 10a.

Referring now to FIGS. 11A-11G, a second embodiment, hereafter referred to as fuel system 10b, is shown disposed within installation frame 102. Fuel system 10b is substantially similar to fuel system 10a and operates in substantially the same manner, except for some of the following differences. As best depicted in FIG. 11C, fuel conduits 30 are installed in a more streamlined manner (e.g., as compared to fuel system 10a), which can possibly reduce the chance of damage before, during, or after installation (e.g., by catching the fuel conduit on external machinery or equipment, possibly resulting in deformation or penetration or the conduit). Additionally, system 10b can comprise more lifting points 130 as compared to system 10a, facilitating increased control when moving the system by installation frame 102. In this embodiment, module mount 134 is mounted on frame member 110 or 114, rather than on base 106. It should be appreciated that variations to the structure and components featured thereon aim to provide flexibility and do not stray from the nature of the invention. Alterations to the location, size, and mounting method of components can be implemented while staying true to the nature of the claims.

Referring now to FIGS. 12A-12C, an installation process for fuel system 10a is depicted. Specifically, FIG. 12A depicts fuel system 10a, along with installation frame 102 being positioned on tailgate 54 of a vehicle (e.g., 50). The positioning can be accomplished via lifting points 130. FIG. 12B then depicts fuel system 10a positioned as desired on tailgate 54. In this position, fasteners can be disposed through fuel tank mounts (e.g., 26a, 26b, and/or 26c) to couple the mounts (and thus, fuel system 10a) to tailgate 54. FIG. 12C then shows the final system after frame members 110 and 114 have been removed.

Some of the present methods for installing a gaseous fuel system for use on a vehicle can comprise a fuel system (e.g., 10a) removably coupled to an installation frame (e.g., 102). Compressed gas fuel tanks (e.g., 14) of the fuel system can be coupled to the first and second frame members (e.g., 110 and 114, respectively) of the installation frame at least by fuel tank mounts (e.g. 26a, 26b, and/or 26c). While the compressed gas fuel tanks 14 are coupled to the first and second frame members, the compressed gas fuel tanks can be coupled to the vehicle via the fuel tank mounts. Then, while the compressed gas fuel tanks 14 are coupled to the vehicle, the first and second frame members can be decoupled from the fuel tank mounts and removed from the vehicle.

Coupling the compressed gas fuel tanks 14 to the first and second frame members can include, for at least one of the fuel tank mounts, fastening first and second fuel tank mount portions (e.g., 158 and 162, respectively) around a neck (e.g., 122) of one of the compressed gas fuel tanks. The first and second fuel tank mount portions can remain fastened around the neck during coupling of the compressed gas fuel tanks to the vehicle and during decoupling of the first and second frame members from the fuel tank mounts. Additionally, while the compressed gas fuel tanks 14 are coupled to the first and second frame members and before the compressed gas fuel tanks are coupled to the vehicle, two or more compressed gas fuel tanks can be connected to one another via one or more rigid fuel conduits (e.g., 30). While the compressed gas fuel tanks 14 are coupled to the first and second frame members and before the compressed gas fuel tanks are coupled to the vehicle, a support bracket (e.g., 18) can be coupled to one or more of the fuel tank mounts and couple a pressure-relief device (e.g., 34) to the bracket. The bracket can remain coupled to the fuel tank mounts during coupling of the compressed gas fuel tanks 14 to the vehicle and during the aforementioned decoupling of the first and second frame members from the fuel tank mounts.

The installation frame can include a base (e.g., 106) removably coupled to the first and second frame members, and before coupling the fuel system to the vehicle, the base can be decoupled from the first and second frame members. After coupling the compressed gas fuel tanks to the first and second frame members, a second installation frame can be stacked upon the first installation frame, wherein the second installation frame can include a second fuel system coupled to first and second frame members of the second installation frame. The stacked set of installation frames can then be transported more conveniently. Once ready for coupling to a vehicle, lifting points (e.g., 130) disposed along the first and second frame members can be used to position the fuel system relative to the vehicle. The fuel system can then be coupled to the tailgate of a vehicle for use, and the first and second frame members can be subsequently removed.

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses, systems, and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus-or step-plus-function limitations, unless such a limitation is explicitly recited in a given claim using the phrase(s) “means for” or “step for,” respectively.

1. A system for installing compressed gas fuel tanks in a vehicle, the system comprising: an installation frame including first and second frame members; and
for each of the first and second frame members, fuel tank mounts configured to be coupled to and along the frame member, each of the fuel tank mounts configured to be simultaneously coupled to:
the frame member;
a neck of a compressed gas fuel tank via a neck passageway of the fuel tank mount; and
a vehicle independently of the frame member such that the fuel tank mount remains coupled to the vehicle when the frame member is decoupled from the fuel tank mount.

2. The system of claim 1, comprising one or more brackets configured to couple at least one of the fuel tank mounts to at least one of the frame members.

3. The system of claim 2, wherein at least one of the brackets includes:
one or more first openings, each configured to receive a fastener to couple the bracket to one of the frame members; and
one or more second openings, each configured to receive a fastener to couple the bracket to one of the fuel tank mounts.

4. The system of claim 3, wherein the first opening(s) each extend into the bracket in a first direction.

5. The system of claim 4, wherein the second opening(s) each extend into the bracket in a second direction that is substantially perpendicular to the first direction.

6. The system of claim 1, wherein at least one of the fuel tank mounts includes one or more first openings, each extending into the fuel tank mount in a first direction and configured to receive a fastener to couple the fuel tank mount to one of the frame members.

7. The system of any of claims 4-6, wherein at least one of the fuel tank mounts includes one or more first passageways, each configured to receive a fastener to couple the fuel tank mount to the vehicle.

8. The system of claim 7, wherein the fuel tank mount includes:
first and second fuel tank mount portions configured to be coupled together such that the fuel tank mount portions cooperate to define the neck passageway; and
one or more second passageways, each configured to receive a fastener to couple the fuel tank mount portions together.

9. The system of claim 8, wherein the first passageway(s) and the second passageway(s) each extend into the fuel tank mount substantially parallel to one another.

10. The system of claim 8 or 9, wherein the first passageway(s) and the second passageway(s) each extend into the fuel tank mount substantially perpendicular to the first direction.

11. The system of any of claims 8-10, wherein the first passageway(s) each have a length that is longer than a length of each of the second passageway(s).

12. The system of any of claims 1-11, comprising one or more brackets configured to be coupled to:
one or more of the fuel tank mounts independently of the installation frame; and one or more pressure-relief devices.

13. The system of any of claims 1-12, wherein, when the fuel tank mounts are coupled to the first and second frame members, for each set of three consecutive fuel tank mounts along one of the frame members, the longitudinal axis of the neck passageway of the middle fuel tank mount of the set is disposed outwardly of a plane including the longitudinal axes of the neck passageways of the outer fuel tank mounts of the set.

14. The system of any of claims 1-13, wherein each of the first and second frame members comprises a plate.

15. The system of any of claims 1-14, wherein the installation frame includes a base configured to be removably coupled to the first and second frame members such that:
the frame members extend parallel to one another; and
a space is defined between the first and second frame members for receiving the compressed gas fuel tanks.

16. The system of claim 15, wherein the base comprises forklift pockets.

17. The system of any of claims 1-16, wherein the installation frame comprises lifting points coupled to each of the first and second frame members.

18. The system of any of claims 1-17, wherein the installation frame comprises a mount configured to be coupled to a fuel management module.

19. The system of claim 18, wherein the mount is configured to be removably coupled to one of the first and second frame members.

20. A system comprising:
first and second systems of any of claims 1-19;
wherein the installation frame of the second system is stacked on top of the installation frame of the first system.

21. The system of claim 20, wherein, for each of the first and second systems, the fuel tank mounts are coupled to the first and second frame members and to the necks of the compressed gas fuel tanks.

22. A method for installing compressed gas fuel tanks in a vehicle, the method comprising: coupling compressed gas fuel tanks to first and second frame members of an installation
frame at least by coupling fuel tank mounts that are coupled to the compressed gas fuel tanks to the frame members;
while the compressed gas fuel tanks are coupled to the first and second frame members, coupling the compressed gas fuel tanks to the vehicle via the fuel tank mounts; and
while the compressed gas fuel tanks are coupled to the vehicle, decoupling the first and second frame members from the fuel tank mounts and removing the first and second frame members from the vehicle.

23. The method of claim 22, wherein:
coupling the compressed gas fuel tanks to the first and second frame members includes, for at least one of the fuel tank mounts, fastening first and second fuel tank mount portions around a neck of one of the compressed gas fuel tanks; and
the first and second fuel tank mount portions remain fastened around the neck during coupling of the compressed gas fuel tanks to the vehicle and during decoupling of the first and second frame members from the fuel tank mounts.

24. The method of claim 22 or 23, comprising, while the compressed gas fuel tanks are coupled to the first and second frame members and before the compressed gas fuel tanks are coupled to the vehicle, connecting two or more of the compressed gas fuel tanks to one another via one or more rigid fuel conduits.

25. The method of any of claims 22-24, comprising, while the compressed gas fuel tanks are coupled to the first and second frame members and before the compressed gas fuel tanks are coupled to the vehicle:
coupling a bracket to one or more of the fuel tank mounts and coupling a pressure-relief device to the bracket;
wherein the bracket remains coupled to the fuel tank mount(s) during coupling of the compressed gas fuel tanks to the vehicle and during decoupling of the first and second frame members from the fuel tank mounts.

26. The method of any of claims 22-25, wherein:
the installation frame includes a base removably coupled to the first and second frame members; and
the method comprises, before coupling the compressed gas fuel tanks to the vehicle, decoupling the base from the first and second frame members.

27. The method of any of claims 22-26, comprising:
after coupling the compressed gas fuel tanks to the first and second frame members, stacking a second installation frame on top of the installation frame;
wherein the second installation frame includes compressed gas fuel tanks coupled to first and second frame members of the second installation frame.

28. The method of claim 27, comprising shipping the stacked installation frames.

29. The method of any of claims 22-28, wherein coupling the compressed gas fuel tanks to the vehicle comprises positioning the first and second frame members relative to the vehicle using lifting points of the installation frame.

30. The method of any of claims 22-29, wherein the compressed gas fuel tanks comprise at least 4 compressed gas fuel tanks.

31. The method of any of claims 22-30, wherein the compressed gas fuel tanks have a capacity of at least 100 diesel gallon equivalent (DGE).

32. The method of any of claims 22-31, wherein coupling the compressed gas fuel tanks to the vehicle comprises coupling the compressed gas fuel tanks to a tailgate of the vehicle.
